(19) United States
(12) Patent Application Publication
(10) Pub. No.: US 2025/0373129 A1
(43) Pub. Date: Dec. 4, 2025

(54) METHOD AND DEVICE FOR PRODUCING LAMINATED CORES FROM LAMINATIONS

(71) Applicant: BAUER LEAN-ENGINEERING GMBH, Vaihingen/Enz (DE)

(72) Inventors: Steffen BAUER, Zaberfeld (DE); Jochen KAUFFMANN, Ebersbach (DE); Christian LANG, Vaihingen/Enz (DE)

(21) Appl. No.: 18/875,731

(22) PCT Filed: Jun. 5, 2023
(86) PCT No.: PCT/EP2023/064999

§ 371 Date: Dec. 17, 2024

(30) Foreign Application Priority Data
Jun. 29, 2022 (DE) 10 2022 116 203.6

(51) Int. Cl. H02K 15/0273; B21D 28/26; B32B 15/01; B32B 37/12; B32B 38/00; B32B 41/00; H02K 15/027

(52) U.S. Cl. CPC H02K 15/0273; B21D 28/26; B32B 15/011; B32B 37/1284; B32B 38/0004; B32B 41/00; H02K 15/027; B32B 2311/30

(57) ABSTRACT

The invention relates to a method and a device for producing laminated cores (2) from laminations (1), in which an adhesive medium is applied as at least one adhesive point (22) to the top of the surface of a sheet metal insulation (21) of a sheet metal strip (5), which is guided horizontally with respect to the direction of gravity, by means of an application unit (35) via an application head (32). Advantages for the structure and function result from the fact that the adhesive medium is transferred as at least one adhesive point (22) to the surface of the sheet metal insulation (21) of the sheet metal strip (5) or a lamination (1) cut from this strip without movable components in the application head (32), the application head (32) being moved perpendicularly relative to the surface of the sheet metal strip (5) in order to transfer the adhesive medium in the form of the at least one adhesive point (22).

The invention relates to a method for producing laminated cores from laminations, in which an adhesive medium is applied as at least one adhesive point to the top side of the surface of a sheet metal insulation of a sheet metal strip guided horizontally with respect to the direction of gravity by means of an application unit via an application head. Furthermore, the invention relates to a device with an application unit for producing laminated cores from laminations, which has an application head. at least one distributor for the adhesive medium with at least one feed for the adhesive medium and a frame for receptacle of the distributor(s) and the at least one application head.

A method and a device of this type are disclosed in EP 1 833 145 B1.

The production of laminated cores consisting of laminations for electrical machines (motors, generators) is carried out economically in a punching process. A coil on a reel, whose magnetic properties, insulation layer and width are already matched to the laminated core to be produced, is fed into a punching press. A real is often followed by a straightening unit. The feed system located on the punching press feeds the sheet metal strip of the coil step by step into the punching tool located in the punching press. The step size is also matched to the laminated core to be produced. Inside the punching press. the punching tool gradually creates the inner contours of the lamination. Once the inner contours have been completed, the lamination is punched out of the coil's sheet metal strip using the punching stamp and transferred to the so-called punching die. To produce a laminated core, the laminations are joined together in the punching die to form a laminated core. The laminated core grows with each working stroke of the punching press. A core brake is located underneath the punching die, which ensures that the counterforce required to join the laminations to the laminated core is applied. With each working stroke of the punching press, the laminated cores in the punching die and core brake are moved downwards by the thickness of the lamination. The core is separated by suspending the device for creating the core connection once, so that two adjacent laminations cannot connect once. There can be several laminated cores inside the core brake. After the laminated cores have been transported through the core brake, the laminated core at the lower end of the core brake is usually transferred to a conveyor system, which conveys the finished laminated cores out of the punching press.

Various methods are used to join the laminations into laminated cores during the punching process, namely stamp core packaging, back stacking and adhesive stacking.

Stamp core packaging creates a punctual connection between adjacent laminations. Embossing nubs are inserted into each lamination during stamp core packaging. The punching die is used to press the embossing nubs of adjacent lamination into one another. The frictional force of the embossing nubs pressed into one another generates the holding force between neighboring laminations and thus gradually creates a laminated core. The core is separated by punching a recess that is dimensioned and positioned in such a manner that no embossing subs can be inserted at these points at least once. This means that two neighboring laminations cannot connect at least once in the punching die. Stamp core packaging is a method used worldwide to produce laminated cores. However, the embossing nubs introduced in the process lead to electrical contact between neighboring lamination, which results in so-called iron losses and thus reduces the efficiency of electrical machines.

Backpacking is a special form of manufacturing laminated cores from laminations and involves the insulation layer of the coil's sheet metal strip having additional adhesive properties. The adhesive properties are selected in such a manner that they are only activated under the Influence of temperature and/or by means of an activator. The adhesive property of the insulation layer ensures a full-surface connection between the laminations. Such a method is described in EP 2 450 189 A1, wherein the method can be integrated into the punching process. The devices required to integrate the backpacking process into the punching process are complex and therefore costly and maintenance-intensive.

Adhesive packaging, as described in the above-mentioned EP 1 833 145 B1, eliminates the efficiency disadvantage of stamp core packaging and the high energy consumption of back-packaging. Drop-shaped adhesive points are applied to the insulation layer of the sheet metal strip. Neighboring lamination is pressed together in the punching die of the punching tool. The adhesive points are distributed over the surfaces of neighboring lamination. When passing through the core brake located under the outlet die, the time is generated in which the adhesive medium cross-links with the laminations to such an extent that the laminated cores are at least hand-tight when leaving the core brake. This type of adhesive bonding creates a flat connection between the lamination in the region of the application points without negatively influencing the magnetic properties of the sheet metal strip and thus the end product. In this adhesive packaging process. which is integrated into the punching process, the adhesive points are applied to the top and/or bottom of the strip surface using a piezo micro-dispensing system. The application unit consists of at least one hon-contact application head and has at least one actuator connected to a controlled valve, which is provided with a piezo crystal. These actively moving parts in the application unit can therefore also be used to apply the adhesive to the underside. The core is separated when the system control sends an interrupt signal to the piezo micro dispensing system to stop the glue point application. Recesses are provided in the tool, the dies and the guides to protect the adhesive points applied to the sheet metal strip. The devices required to integrate the adhesive packaging process into the punching process are therefore also complex, maintenance-intensive and therefore also cost-intensive.

DE 203 18 993 U1 shows an adhesive packaging process in which a cutting stamp preferably has a flat end surface, but which can also be interrupted and thus contain recesses. It is shown that adhesive points are applied to the sheet metal strip from below. This adhesive packaging process is based on the strip material coming into contact with the surface of the dispensing unit, which moves a ball and thus releases the adhesive flow.

EP 3 217 520 A1 and similarly KR 101566486 B1 show an adhesive packaging process in which an application unit for the adhesive medium is integrated into the lower part of the punching tool. The adhesive medium is supplied under pressure and at a predetermined flow rate to outlet nozzles in order to apply it to the underside surface of the sheet metal strip. An activator for the adhesive medium can be applied together with strip lubrication. Adhesive droplet residues that are not transferred can be drained off in channels through the lower part of the tool.

JP 2001321850 A presents an adhesive packaging process in which adhesive drops are applied to the sheet metal strip inside the punching tool. Before the adhesive drops are applied to the sheet metal strip, it is cleaned. The curing of the adhesive medium can be supported by applying heat in the core brake.

In an adhesive packaging process specified in DE 35 35 573 A1, in which the control of the core separation is based on a measurement of the thickness of a sheet metal strip fed in. the individual laminations are connected within the punching process to form laminated cores with an adhesive medium that is applied via a dosing apparatus. The adhesive is fed with a hose from the dosing apparatus to the punching stamp and with or without a hose through the punching stamp. A heating device can be provided in the channel under a punched part discharge device and a core brake to support adhesive curing. If a two-component adhesive is used, it is dispensed directly through the hose channel of the pressure plate and the cutting stamp insert. The activator is applied to the underside of the punched part in a phase-shifted manner at the specified adhesive points using standard dispensing needles. When using one component adhesive, the adhesive is applied to the underside of the punched part with the dispensing needle device through the dispensing needles.

All known adhesive laminating processes on the market for the production of laminated cores from laminations use complex distribution and dosing or application systems for the adhesive medium and/or are prone to contamination in the region of the application head.

The invention is based on the object of providing a method or a device of the type mentioned at the beginning. which provides an application method for applying adhesive points to the surface of the sheet metal strip or the lamination which is as simple and low-maintenance as possible and thus inexpensive.

According to the invention, this object is achieved in the production of laminated cores by the method having the features of claim 1 and in the device having the features of claim 14.

In the method, it is provided that the adhesive medium is transferred as at least one adhesive point to the surface of the sheet metal insulation of the sheet metal strip or a lamination cut therefrom without movable components in the application head, wherein the application head is moved perpendicularly relative to the surface of the sheet metal strip in order to transfer the adhesive medium in the form of the at least one adhesive point.

In the device, it is provided that the distributor is manufactured using an additive method, in particular a 3D printing method.

With these measures, the gluing process is advantageously integrated into the manufacturing process of the laminated cores, wherein it is carried out during or downstream of the punching process. Detailed investigations by the inventors have shown that with these measures, the adhesive feed for applying the adhesive points can be controlled or regulated exactly as specified without the need for a complex design of the feed unit without movable components in the application head. Contamination of the dosing system, in particular the application head, is at least largely avoided. By feeding the adhesive medium to the top of the surface of the sheet metal insulation by moving the application head perpendicularly to the direction of gravity, i.e. without any moving parts and their actuation as in the prior art the adhesive medium is released in a precisely predeterminable quantity under the effect of gravity and by the tunable kinetic energy, wherein the influence of a cohesive force acting in the process can also be included If necessary. The combination of physical forces used in this manner. together with the simple structure of the application unit, results in a precise, reliable and economical application system for the adhesive medium when packaging lamination. It should be noted that the term “point” is not to be understood strictly mathematically in the present case, but has a geometric extension due to its volume.

The device for producing the laminated cores can be easily and optimally adapted to the application of the adhesive medium with the aforementioned parameters by forming the distributor (in which there are also no moving parts) using the additive method, in particular the 3D printing method, with high precision, any channel routing with any channel cross-sections and connection geometries for the application head(s).

Advantageous embodiments of the invention are given in the dependent claims.

When integrating the adhesive medium application into the punching process. it is advantageous for the application head to be moved synchronously with the working stroke of the punching press.

In particular. if the adhesive medium is applied downstream of the punching process. an advantageous embodiment is that the application head is not moved synchronously with the working stroke of the punching press.

Advantageously, the required volume of adhesive medium at the application head is provided by the pressure level and pulse duration as a function of the viscosity of the adhesive medium and the kinetic energy of the application head (also in coordination with the design of the application head).

In a further advantageous embodiment of the method, for an exact transfer of the adhesive medium to the sheet metal insulation or the lamination, it is provided that the transfer of the adhesive medium as an adhesive point to the sheet metal insulation of the sheet metal strip of the lamination is supported by the kinetic energy of a distributor of the application unit and the application head, and the gravitational force of the adhesive medium with or without using the adhesive force of the adhesive point on the sheet metal strip.

The fact that the application head does not touch the surface of the sheet metal insulation of the sheet metal strip or the lamination when dispensing the adhesive medium, wherein the distance between the application head and the sheet metal strip of the lamination is at most 5 mm, preferably at most 1 mm. also contributes to the precise functioning and integration of the method into the manufacturing process of the laminated core.

For a precisely coordinated application of the adhesive medium to form the best possible adhesive surface of adhesive bond between the lamination, it is also advantageously provided that the surface of the sheet metal insulation of the lamination is only partially wetted during the application of the adhesive points.

Further advantageous measures for forming the adhesive surfaces consist of monitoring the application of the adhesive points to the sheet metal insulation of the sheet metal strip or the lamination by sensors to check for the presence and size of partial wetting.

The precise adjustment of the adhesive surface on the lamination also contributes to the adjustment of the volume of the respective adhesive point.

A high quality of the formation of the adhesive surfaces during the manufacturing process and the adhesive bond is also ensured by the fact that the volume of the respective adhesive point is independently regulated by a control circuit.

An even application of the adhesive medium for optimizing the adhesive surfaces is further supported by the fact that the application of several adhesive points to the surface of the sheet metal strip or the lamination takes place via at least one distributor with at least one feed for the adhesive medium and via the at least one application head connected to the at least one distributor. One or more application heads can be attached to a distributor, wherein, for example, each application head can only apply one adhesive point per movement sequence. In an alternative embodiment, several adhesive points can also be applied with one application head.

Integration of the adhesive application into the punching process results from the fact that the application unit for applying the adhesive point is located within the punching process.

Another advantageous application of the adhesive medium is that the application unit for applying the adhesive medium is located outside the punching process, in particular downstream of it.

An advantageous further embodiment of the method is that the distributor and the application head for applying the adhesive medium are located inside the punching stamp of the punching tool.

The device is advantageously designed in that the at least one distributor for the adhesive medium is made of a metallic material or in that the at least one distributor for the adhesive medium is made of a non-metallic material, in particular a plastic, preferably a thermosetting plastic.

One design of the device that is particularly advantageous for the structure and function is that the application head does not contain any movable components. In particular no driven components. In conjunction with the additive method used to manufacture the distributor, this design results in a structure of the application system that can be easily adapted to the required function and works largely trouble-free.

A sensor, in particular an optical sensor, which monitors the presence and size of the partial wetting of a sheet metal strip or the lamination with the adhesive points, wherein the monitoring by the sensor takes place during the application of the adhesive medium or downstream of the application of the adhesive medium, also contributes to precise functioning and reliable monitoring of a uniformly high quality of the adhesive application. The term “sensor” is to be understood in a broad sense, wherein the optical sensor can also be, for example, a camera system for image processing for a target/actual comparison.

A further embodiment that is advantageous for the function and structure of the device is that the volume of the adhesive points can be adjusted, in particular independently by a control circuit with a sensor for monitoring the partial wetting of the sheet metal strip or the lamination with the adhesive points.

A high quality of application and distribution of the adhesive medium is also supported by the fact that the distance between the application heads is at most 5 mm, preferably at most 3 mm. Larger distances may also be possible depending on the product.

A laminated core which meets high demands in terms of structure and function is obtained by producing the laminated core by a method according to any of claims 1 to 13.

The invention is explained in more detail below by means of examples with reference to the drawings. In the drawings:

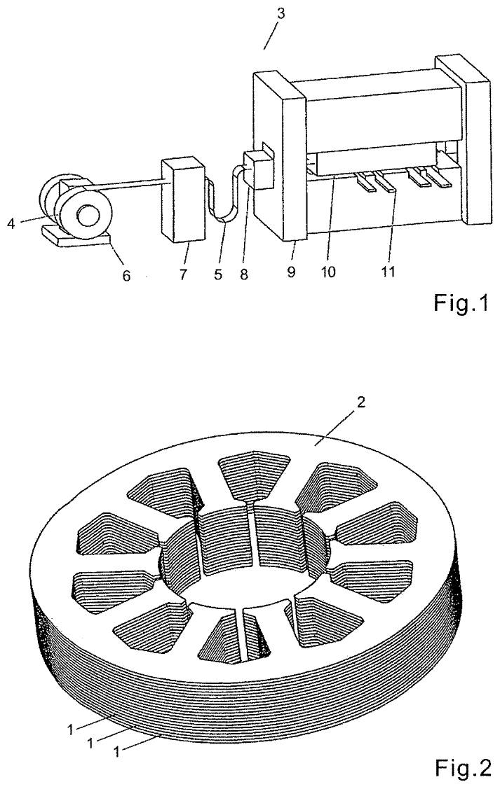

FIG. 1 shows a schematic representation of a device for producing a laminated core from a sheet metal strip unwound from a coil in a punching process with a punching press and a device for stacking laminations to form the laminated core,

FIG. 2 shows a perspective view of a laminated core formed from a number of laminations,

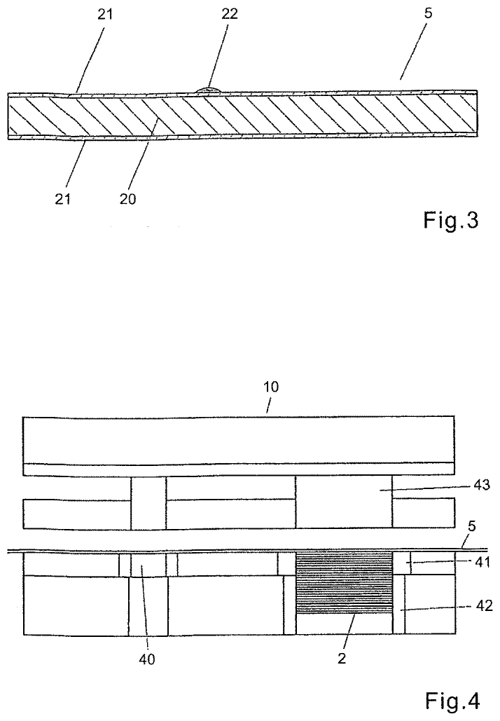

FIG. 3 shows a portion of a sheet metal strip consisting of a magnetic core material and insulating layers applied on both sides, to which an adhesive point is applied, in a sectional view,

FIG. 4 shows a simplified representation of an embodiment of a punching tool arranged in the punching process, in which a sheet metal strip is processed step by step into sheet metal lamination and a laminated core, consisting of regions for producing the inner contours of the sheet metal lamination, a punching stamp, a punching die and a core brake in a side view,

FIG. 5 shows a schematic representation of an application unit integrated into the punching process according to the invention, comprising a frame, a distributor with a feed for the adhesive medium, a plurality of application heads and a sensor for monitoring the application of the adhesive points to the sheet metal strip,

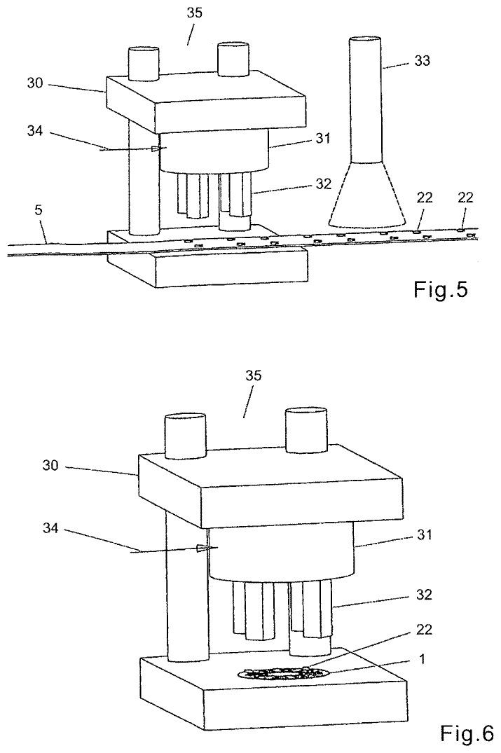

FIG. 6 shows an application unit downstream of the punching process according to the invention, comprising a frame, a distributor with a feed for the adhesive medium and a plurality of application heads for applying the adhesive points to the lamination,

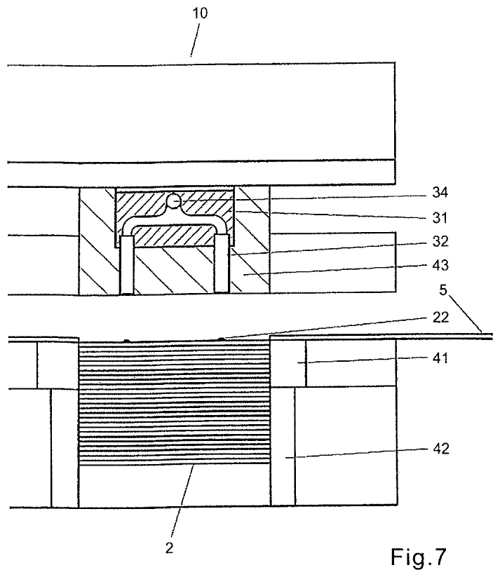

FIG. 7 shows a distributor integrated according to the invention with a feed for the adhesive medium and a plurality of application heads for applying the adhesive points to the lamination in a punching stamp of the punching tool, and

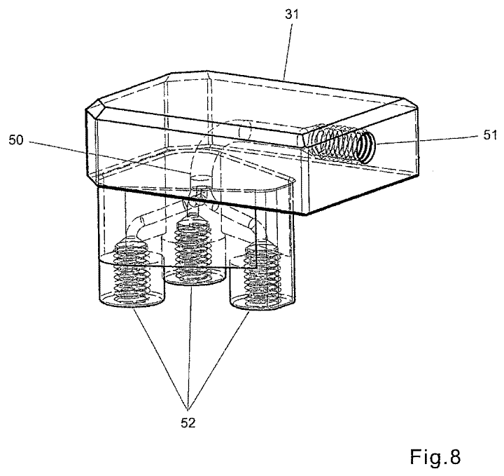

FIG. 8 shows an embodiment of a distributor in perspective glass view, produced using a 3D printing method.

FIG. 1 shows schematically a device for producing laminated cores 2 from laminations 1 in large quantities within a punching process 3. A laminated core 2 consisting of a plurality of laminations 1 is shown as an example in FIG. 2

To produce the laminated cores 2. s sheet metal strip 5 is unwound from a coil 4 using a reel 6. optionally fed to a straightening unit 7 and fed step by step into a working space of a punching press 9 and a punching tool 10 by means of a feed system 8. As FIG. 3 shows in part, the sheet metal strip 5 consists of a (magnetic) core material 20 with insulating layers 21 applied to both sides.

Within the punching tool 10, positioning holes are first punched into the sheet metal strip 5, which ensure an exact step width for the step-by-step advancement of the sheet metal strip 5 within the punching tool 10. The inner contours of the lamination 1 ere then punched step by step into the sheet metal strip 5 in the punching tool 10 in the regions 40 for producing the inner contours. When all the inner contours of the lamination 1 to be pre-punched have been punched into the sheet metal strip 5, the lamination 1 is punched out of the sheet metal strip 5 with a punching stamp 43 and transferred to a punching die 41 with a core brake 42 underneath (see FIG. 4).

FIG. 5 shows an embodiment example of the invention. in which an application unit 35 for an adhesive medium for joining the stacked lamination 1 is located in the working space of the punching press 9 between the feed system 8 and the punching tool 10. The sheet metal strip 5. whose bandwidth and strip thickness are matched to the outer dimensions of the lamination 1, is fed to the punching tool 10 in steps by the feed system 8, wherein the step width is adapted to the outer diameter of the lamination 1. The sheet metal strip 5 also passes through the application unit 35 step by step. The application unit 35 is positioned in the working space of the punching press 9 in such a manner that adhesive points 22 can be applied to the insulation layer 21 of the sheet metal strip 5 in the correct position (see FIG. 3).

The application unit 35 consists of a frame 30 in which a distributor 31 is mounted. In turn. application heads 32 are mounted on the distributor 31 and their number and position are selected and arranged in such a manner that adhesive points 22 can be applied to the sheet metal strip in the exact position as long as the sheet metal strip is not moved by the feed system.

To apply the adhesive points 22 to the sheet metal strip 5, an adhesive medium is supplied in pulsating form from a separate adhesive container (not shown here, usually located in a pneumatic and fluidic part of a control cabinet) spaced from the application unit 35 by means of a dosing pump or a compressed air valve (which generates a pressure in the adhesive container) to the distributor 31 and the application heads 32 mounted thereon via a supply for the adhesive medium 34. A pulse frequency for feeding the adhesive medium is synchronized with a working frequency of the punching press 9. The pulse duration and the pressure are adjusted in such a manner that the adhesive points 22 on the metal strip 5 reach a defined size. The distributor 31 has a channel system that distributes the adhesive medium evenly to the application heads 32. A plate of the frame 30. to which the distributor 31 with the application heads 32 is mounted, can be moved up and down in a vertical direction (with respect to the direction of gravity or geodesically). The vertical movement can be synchronized or not synchronized with the working stroke of the punching press 9.

If the adhesive medium is available at the lower end of the application heads 32, the distributor 31 and the application heads 32 in the frame 30 are moved vertically in the direction of the sheet metal strip 5 until the application heads 32 do not touch the sheet metal strip 5. In this case, the distance between the application heads 32 and the sheet metal strip 5 is at most 5 mm, preferably at most 1 mm. Supported by the kinetic energy of the distributor 31 and the application heads 32, the gravitational force of the adhesive medium at the lower end of the application heads 32 and possibly also an acting adhesive force of the adhesive medium on the sheet metal strip 5, the adhesive medium is transferred to the upper side of the sheet metal strip 5 in the form of adhesive points 22. When the adhesive points 22 have been transferred to the sheet metal strip 5, the distributor 31 with the application heads 32 is moved vertically upwards again in the frame 30 and, after completion of the punching operation in the punching tool 10, the sheet metal strip 5 is moved one step further by the feed system 8.

The adhesive point application is repeated until the required number of laminations 1 with adhesive points 22 is reached to produce the laminated core 2. The application of the adhesive points 22 to the sheet metal strip 5 is then interrupted once for core separation by interrupting the pulse for feeding the adhesive medium 34 into the distributor 31 and the application heads 32 once. The core separation can be supported by the fact that the vertical movement of the distributor 31 and the application heads 32 stops simultaneously with the suspension of the pulse for providing the adhesive medium.

The monitoring of a successful application of the adhesive points 22. in particular the presence and size or volume of the adhesive points 22 on the sheet metal strip 5, is carried out by one or more sensors 33 downstream of the application unit 35. In a particular embodiment, the size of the adhesive points 22 is controlled by the pulse duration and the pressure used to provide the adhesive medium via the sensors 33 for monitoring the size of the adhesive points 22.

After the adhesive points 22 have been applied to the sheet metal strip 5, the sheet metal strip 5 is conveyed step by step through the punching tool 10 and the inner contours of the lamination 1 are punched into the sheet metal strip 5 in the regions 40 for producing the inner contours, as shown in FIG. 4. The punching stamp 43 is located in the punching unit of the punching tool 10, which punches out a lamination 1 from the sheet metal strip 5 with each working stroke of the punching press 9 and transfers if to the punching die 41. When the punched lamination 1 touches the underlying lamination 1, the adhesive points 22 are pressed together between the two adjacent laminations 1 and thereby distributed over the surfaces of the two adjacent laminations 1.

With each working stroke of the punching press 9, another lamination 1 is pressed into the punching die 41 by the punching stamp 43 and the stack of lamination 1 below it is moved downwards by the distance of the sheet thickness. In order to generate time for the curing of the adhesive points 22 distributed over the surface between the laminations 1 to form the laminated cores 2, the core brake 42 is located below the punching die 41, which generates an axial holding force in the form of friction for the laminated cores 2 within the die 41 and the core brake 42 by means of a radial pretensioning force. When a finished laminated core 2 reaches the lower end of the core brake 42, it is transferred there by gravity or by means of a lift system to a conveyor system 11, which conveys the finished laminated cores 2 out of the punching press 9.

In a further embodiment of the invention shown in FIG. 6. an application unit 35 is arranged downstream of the punching process 3. This embodiment allows further processing steps to be carried out on the lamination 1, such as heat treatment, between the punching process 3 and the application of the adhesive points 22 to the insulating layer 21 of the laminations, which can weaken or destroy a previously created adhesive bond between the lamination 1 and the laminated core 2.

The application unit 35 again has a frame 30 in which a distributor 31 is mounted. The application heads 32 are mounted on the distributor 31 with a feed for the adhesive medium 34, the number and position of which are selected and arranged in such a manner that adhesive points 22 can be applied to the lamination 1 in the exact position.

First, a lamination 1 is inserted manually or automatically into the application unit 35 in a precise position. To apply the adhesive points 22 to the lamination 1, an adhesive medium is supplied with a pulse via the adhesive medium feed 34 in the distributor 31 and the application heads 32 mounted on it. The pulse duration and the pressure are adjusted in such a manner that the adhesive points 22 on the lamination 1 reach a defined, predetermined size or volume. The distributor 31 has a channel system that distributes the adhesive medium evenly to the application heads 32. A plate of the frame 30, to which the distributor 31 with the application heads 32 is mounted, can be moved up and down in a vertical direction. The vertical movement can be driven manually or automatically. If the adhesive medium is available at the lower end of the application heads 32, the distributor 31 and the application heads 32 in the frame 30 are manually or automatically driven vertically in the direction of the lamination 1 until the application heads 32 do not touch the lamination 1. In this case, the distance between the application heads 32 and the lamination 1 is at most 5 mm, preferably at most 1 mm. Supported by the kinetic energy of the distributor 31 and the application heads 32, the gravitational force of the adhesive medium at the lower end of the application heads 32 and the adhesive force of the adhesive medium on the lamination 1. if present, the adhesive medium is transferred to the upper side of the lamination 1 in the form of adhesive points 22. When the adhesive points 22 have been transferred to the lamination, the distributor 31 with the application heads 32 is moved vertically upwards again in the frame to its starting position.

The lamination 1 is then removed manually or automatically from the application unit 35 and fed to a stacking unit, in which the lamination 1 is stacked and pressed into the correct position. By pressing adjacent lamination 1 onto one another, the adhesive points 22 are distributed over the surface between the laminations. By applying pressure and time, the adhesive points or adhesive surfaces harden and adjacent laminations 1 are joined to form laminated cores 2. Finished laminated cores 2 are removed from the stacking unit manually or automatically.

In a third embodiment of the invention shown in FIG. 7, the distributor 31 and the application heads 32 are integrated in the punching stamp 43 within the punching tool 10. This embodiment has the advantage of particularly short distribution paths for the adhesive medium.

To apply the adhesive points 22 to the sheet metal strip 5, an adhesive medium is also supplied in pulsating form to the distributor 31 and the application heads 32 mounted thereon via a feed for the adhesive medium 34 according to this embodiment example.

The pulse frequency is synchronized with the working frequency of the punching press 9. The pulse duration and the pressure are adjusted in such a manner that the adhesive points 22 on the metal strip 5 reach a defined size. The distributor 31 has a channel system that distributes the adhesive medium evenly to the application heads 32. The adhesive medium is made available at the lower ends of the application heads 32 at the earliest when the punching stamp 43 is moved upwards during the upward movement of the press plunger and has reached a distance of at least 1 mm from the surface of the previously punched lamination 1. The provision of the adhesive medium at the lower end of the application heads 32 is completed at the latest when the distance between the punching stamp 43 and sheet metal strip 5 is still at least 1 mm during the downward movement of the punching stamp 43 by the press plunger. When the punching stamp 43 touches the sheet metal strip 5 during the downward movement and the punching process of the sheet metal lamination 1 from the sheet metal strip 5 begins, the adhesive medium is transferred from the application heads 32 to the sheet metal strip in the form of adhesive points 22. The application heads 32 do not touch the sheet metal strip 5 during the application of the adhesive medium to the sheet metal strip 5, wherein the distance between the application heads 32 and the sheet metal strip 5 is at most 5 mm, preferably at most 1 mm. Supported by the kinetic energy of the distributor 31 and the application heads 32 in the punching stamp 43, the gravitational force of the adhesive medium at the lower end of the application heads 32 and under the effect of any adhesive force of the adhesive medium on the sheet metal strip 5. the adhesive medium is transferred to the upper side of the sheet metal strip 5 in the form of adhesive points 22. When the adhesive points 22 have been transferred to the sheet metal strip 5, the process of punching out the lamination 1 from the sheet metal strip has been completed and the punch 43 has safely left the sheet metal strip 5 during its upward movement, the sheet metal strip 5 is moved one step further by the feed system 8.

The adhesive point application is repeated until the required number of laminations 1 with adhesive points 22 is reached to produce the laminated core 2.

The application of the adhesive points 22 to the sheet metal strip 5 is then interrupted once for core separation by interrupting the pulse for feeding the adhesive medium 34 into the distributor 31 and the application heads 32 once. The core separation can be supported by lifting the distributor 31 and the application heads 32 inside the punching stamp 43 once by at least 0.5 mm at the same time as the pulse for providing the adhesive medium is interrupted under automatic drive.

With each working stroke of the punching press 9, a lamination is punched out of the sheet metal strip 5 and transferred to the punching die. When the punched lamination 1 touches the underlying lamination 1, the adhesive points 22 are pressed together between the two adjacent laminations 1 and thereby distributed over the surfaces of the two adjacent laminations 1.

With each working stroke of the punching press 9, another lamination 1 is pressed into the punching die 41 by the punching stamp 43 and the stack of lamination 1 below it is moved downwards by the value of the sheet thickness. In order to generate time for the adhesive points between the laminations 1 to harden to form the laminated cores 2, the core brake 42 is located below the punching die 41, which generates an axial holding force in the form of friction for the laminated cores 2 within the die 41 and the core brake 42 by means of a radial pretensioning force When a finished laminated core 2 reaches the lower end of the core brake 42. it is transferred there by gravity or a lift system to a conveyor system 11, which conveys the finished laminated cores 2 out of the punching press 9.

FIG. 8 shows an example of a distributor 31, manufactured using a 3D printing method, with an internal distributor channel 50, which introduces the adhesive medium from the supply of the adhesive medium 34 into the distributor 31 via the interface St or connection point. The adhesive medium is fed in the distributor 31 via the channel system 50 to the three other interfaces 52 and transferred there to the application heads 32. Alternatively, there may be more or less than three additional interfaces. The particular shape of the distributor channel 50 is advantageously manufactured from a thermosetting plastic using a 3D printing method.

1. Method of producing laminated cores (2) from laminations (1), in which an adhesive medium is applied as at least one adhesive point (22) to the upper side of the surface of a sheet metal insulation (21) of a sheet metal strip (5) guided horizontally with respect to the direction of gravity by means of an application unit (35) via an application head (32),
characterized in that
the adhesive medium is transferred as at least one adhesive point (22) to the surface of the sheet metal insulation (21) of the sheet metal strip (5) or a lamination (1) cut from the strip without movable components in the application head (32), the application head (32) being moved perpendicularly relative to the surface of the sheet metal strip (5) in order to transfer the adhesive medium in the form of the at least one adhesive point (22).

2. Method according to claim 1,
characterized in that
the application head (32) is moved synchronously with the working stroke of the punching press (9).

3. Method according to claim 1,
characterized in that
the application head (32) is not moved synchronously with the working stroke of the punching press (9).

4. Method claim 1,
characterized in that
the transfer of the adhesive medium as an adhesive point (22) to the sheet metal insulation (21) of the sheet metal strip (5) or the lamination (1) is supported by the kinetic energy of a distributor (31) of the application unit (35) and the application head (32), and the gravitational force of the adhesive medium with or without using the adhesive force of the adhesive point (22) on the sheet metal strip (5).

5. Method according to claim 1,
characterized in that
the application head (32) does not touch the surface of the sheet metal insulation (21) of the sheet metal strip (5) or the lamination (1) when dispensing the adhesive medium, wherein the distance between the application head (32) and the sheet metal strip (5) or the lamination (1) is at most 5 mm, preferably at most 1 mm.

6. Method according to claim 1,
characterized in that
the surface of the sheet metal insulation (21) of the lamination (1) is only partially wetted during the application of the adhesive points (22).

7. Method according to claim 1,
characterized in that
the application of the adhesive points (22) to the sheet metal insulation (21) of the sheet metal strip (5) or the lamination (1) is monitored by sensors (33) for the presence and size of partial wetting.

8. Method according to claim 1,
characterized in that
the volume of the respective adhesive point (22) is adjusted.

9. Method according to claim 1,
characterized in that
the volume of the respective adhesive point (22) is regulated independently by a control circuit.

10. Method according to claim 1,
characterized in that
the application of several adhesive points (22) to the surface of the sheet metal strip (5) or the lamination (1) takes place via at least one distributor (31) with at least one supply for the adhesive medium (34) and via the at least one application head (32) connected to the at least one distributor (31).

11. Method according to claim 1,
characterized in that
the application unit (35) for applying the adhesive point (22) is located within the punching process (3).

12. Method according to claim 1,
characterized in that
the application unit (35) for applying the adhesive medium (22) is located outside the punching process (3), in particular downstream thereof.

13. Method according to claim 1,
characterized in that
the adhesive medium is applied by means of an embodiment in which the distributor (31) and the application head (32) are located inside the punching stamp (43) of the punching tool (10).

14. Device with an application unit (35) for producing laminated cores (2) from laminations (1), which has an application head (32), at least one distributor (31) for the adhesive medium with at least one feed for the adhesive medium (34) and a frame (30) for receptacle of the distributor(s) (31) and the at least one application head (32),
characterized in that
the distributor (31) is manufactured using an additive method, in particular a 3D printing method.

15. Device according to claim 14,
characterized in that
the at least one distributor (31) for the adhesive medium is made of a metallic material.

16. Device according to claim 14,
characterized in that
the at least one distributor (31) for the adhesive medium is made of a non-metallic material, in particular a plastic, preferably a thermosetting plastic.

17. Device according to claim 14,
characterized in that
the application head (32) does not contain any movable components, in particular no driven components.

18. Device according to claim 14,
characterized in that
a sensor (33), in particular an optical sensor (33), is present which monitors the presence and the size of the partial wetting of a sheet metal strip (5) or the lamination (1) with the adhesive points (22), wherein the monitoring by the sensor (33) takes place during the application of the adhesive medium or takes place downstream of the application of the adhesive medium.

19. Device according to claim 14,
characterized in that
the volume of the adhesive points (22) is adjustable, in particular independently by a control circuit with a sensor (33) for monitoring the partial wetting of the sheet metal strip (5) or the lamination (1) with the adhesive points (22).

20. Device according to claim 14,
characterized in that
the distance between the application heads (32) is at most 5 mm, preferably at most 3 mm.

21. Laminated core (2) consisting of laminations (1),
characterized in that
the laminated core (2) is produced by a method according to claim 1.
